(19) United States
(12) Patent Application Publication
(10) Pub. No.: US 2026/0339517 A1
(43) Pub. Date: Oct. 29, 2026

(54) TECHNOLOGIES FOR DATA TIERING ACROSS ACTIVE AND PASSIVE STORAGE SITES

(71) Applicant: Dell Products L.P., Round Rock, TX (US)

(72) Inventors: Mikhail Borisov, Dublin (IE); Karthik Prabakaran, BANGALORE (IN); Durgaprakash Balla, BANGALORE (IN)

(21) Appl. No.: 19/189,038

(22) Filed: Apr. 24, 2025

(51) Int. Cl. G06F 3/06

(52) U.S. Cl. CPC G06F 3/0613; G06F 3/0647; G06F 3/065; G06F 3/067

(57) ABSTRACT

Data tiering across active and passive storage sites is described. Data can be stored at an active storage site that includes a first hot tier with storage having a higher performance than storage of a first cold tier. A replicated version of the data can be stored as copied data at a passive storage site that includes a second hot tier with the higher performance storage and a second cold tier with the lower performance storage. This storing of the data can comprise storing the copied data at the passive storage site per a first tiering mode requiring the copied data be stored in the second cold tier. Further, an operational disruption at the active storage site can be detected and, in response, a second tiering mode can be implemented where a migration portion of the copied data is migrated to the second hot tier of the passive storage site.

### BACKGROUND

Most modern data storage systems support data tiering. Data tiering is a strategic approach in data management that involves categorizing data into different storage tiers based on certain parameters, such as usage, value, and performance needs. Data tiering may assist organizations to optimize storage costs while ensuring that critical data remains highly accessible. Data may also be replicated across different storage sites to ensure data redundancy, disaster recovery, and business continuity, as unplanned events like hardware failures or cyber-attacks could otherwise disrupt access to data and potentially cause significant financial and reputational damage. Data replication, for example, may include replicating data from a local active site to a remote passive site. Because of the different access patterns for the data between the two sites, extending the same data tiering configuration from the local active site to the remote passive site can lead to inefficiencies.

The above-described context with respect to conventional systems is merely intended to provide an overview of current technology and is not intended to be exhaustive. Other contextual description, and corresponding benefits of some of the various non-limiting embodiments described herein, will become further apparent upon review of the following detailed description.

### SUMMARY

The following presents a simplified summary of the disclosed subject matter to provide a basic understanding of various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method is described herein. The method may include storing, by a data management system that manages storage across an active storage site and a passive storage site and that comprises at least one processor, data at the active storage site. The active storage site comprises a first tier having a higher performance storage medium and a second tier having a lower performance storage medium. The storing comprises accessing primary site tiering logic that applies to the active storage site. The primary site tiering logic comprises data type rules for classification of the data between data types, the data types comprising at least a first data type and a second data type, and tier rules that designate tiers in which respective data types are stored, the tier rules designating the first tier for storage of the first data type and the second tier for storage of the second data type. The storing further comprises classifying the data in accordance with the data type rules. The classifying results in a first portion of the data being classified as the first data type and a second portion of the data being classified as the second data type. The storing further includes storing the data in accordance with the tier rules. The storing results in the first portion of the data and the second portion of the data being stored in the first tier and the second tier, respectively. The method may further include replicating, by the data management system, the data for storage as copied data at the passive storage site. The passive storage site comprises a third tier having the higher performance storage medium and a fourth tier having the lower performance storage medium. The replicating comprises instructing the primary site tiering logic and the copied data be transmitted from the active storage site to the passive storage site. After the copied data is received by the passive storage site, the copied data is stored at the passive storage site in accordance with a first tiering mode. The first tiering mode comprises the copied data being stored in a single default tier that comprises the fourth tier of the passive storage site. The replicating further comprises detecting a triggering event signaling that an operational disruption is occurring at the active storage site. The replicating further comprises, in response to detecting the triggering event, implementing a second tiering mode for storage of the copied data at the passive storage site. The implementing of the second tiering mode comprises: identifying a migration portion of the copied data, resulting in an identified migration portion, and instructing the identified migration portion of the copied data be migrated from being stored in the fourth tier to being stored in the third tier of the passive storage site.

In an example embodiment, a data management system is described herein. The data management system may include at least one processor and at least one memory that stores executable instructions that, when executed by the at least one processor, facilitate performance of operations. The operations comprise storing data at an active storage site. The active storage site comprises a first tier having a higher performance storage medium and a second tier having a lower performance storage medium. The storage of the data at the active storage site comprises accessing primary site tiering logic that applies to the active storage site. The primary site tiering logic comprises data type rules for classification of the data between a first data type and a second data type, and tier rules that designate the first tier for storage of the first data type and the second tier for storage of the second data type. The storage of the data at the active storage site further comprises classifying the data in accordance with the data type rules. The classifying results in a first portion of the data being classified as the first data type and a second portion of the data being classified as the second data type. The storage of the data at the active storage site further comprises storing the data in accordance with the tier rules. The storing results in the first portion of the data and the second portion of the data being stored in the first tier and the second tier, respectively. The operations further comprise storing a replicated version of the data as copied data at a passive storage site. The passive storage site comprises a third tier having the higher performance storage medium and a fourth tier having the lower performance storage medium. The storage of the replicated version of the data comprises storing the copied data at the passive storage site in accordance with a first tiering mode that comprises storing the copied data in a single default tier that comprises the fourth tier of the passive storage site. The storage of the replicated version of the data further comprises detecting a triggering event signaling that an operational disruption is occurring at the active storage site. The storage of the replicated version of the data further comprises, in response to detecting the triggering event, implementing a second tiering mode for storage of the copied data at the passive storage site that comprises determining a first portion of the copied data and a second portion of the copied data, the first portion of the copied data is of the first data type, and the second portion of the copied data is of the second data type, and instructing the first portion of the copied data be migrated from being stored in the fourth tier to being stored in the third tier of the passive storage site.

In an example embodiment, a method is described herein. The method may include storing data at an active storage site, where the active storage site includes a first hot tier with a higher performance storage medium and a first cold tier with a lower performance storage medium. This storing involves accessing the primary site tiering logic that applies to the active storage site, where the primary site tiering logic includes data type rules for classifying data into a first data type and a second data type, as well as tier rules that designate the first hot tier for storing the first data type and the first cold tier for storing the second data type. The method further includes classifying the data in accordance with the data type rules and storing the classified data in accordance with the tier rules, such that the first portion of the data, classified as the first data type, is stored in the first hot tier, and the second portion of the data, classified as the second data type, is stored in the first cold tier. The method also includes storing a replicated version of the data as copied data at a passive storage site, where the passive storage site includes a second hot tier with the higher performance storage medium and a second cold tier with the lower performance storage medium. This storing involves storing the copied data at the passive storage site in accordance with a first tiering mode, which requires storing the copied data in a single default tier that comprises the second cold tier of the passive storage site. The method then includes detecting a first triggering event that signals that an operational disruption is occurring at the active storage site and, in response, implementing a second tiering mode for storing the copied data at the passive storage site. The second tiering mode includes identifying a migration portion of the copied data, resulting in an identified migration portion, and instructing that the identified migration portion of the copied data be migrated from the second cold tier to the second hot tier of the passive storage site. The method further includes detecting a second triggering event that signals that the operational disruption at the active storage site is no longer occurring and, in response, restoring the first tiering mode for storing the copied data at the passive storage site.

To the accomplishment of the foregoing and related ends, the disclosed subject matter includes one or more of the features hereinafter more fully described. The following description and the annexed drawings set forth in detail certain illustrative example embodiments of the subject matter. However, these example embodiments are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Features and advantages of the present technique will become more apparent from the following detailed description of example embodiments thereof taken in conjunction with the accompanying drawings in which:

FIG. 1 illustrates an example embodiment of a data management system that may utilize techniques described herein according to various embodiments;

FIG. 2 illustrates an example of operation of the embodiment of a data management system in FIG. 1;

FIG. 3 illustrates an example data management system having higher and lower performance storage tiers that may utilize techniques described herein according to various embodiments;

FIG. 4 illustrates an example tiered data management system depicting operation according to various embodiments;

FIG. 5 illustrates an example tiered data management system depicting operation according to various embodiments;

FIG. 6 illustrates a method for managing data storage across tiered active and passive storage sites according to example embodiments;

FIG. 7 illustrates a method for managing data storage across tiered active and passive storage sites according to example embodiments;

FIG. 8 illustrates a method for managing data storage across tiered active and passive storage sites according to example embodiments;

FIG. 9 is an example of an embodiment of a computer system that may utilize the techniques described herein; and

FIG. 10 is an example of an embodiment of a storage server that may utilize the techniques described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments. Like reference numerals have been used to illustrate like components across the figures.

Many modern data storage systems implement data tiering as part of their data management practices. As used herein, data tiering refers to the practice of sorting data into various storage tiers based on factors such as frequency of access, importance, and required performance levels. This approach helps organizations reduce storage costs while ensuring data remains sufficiently accessible and safeguarded.

Data is often duplicated across multiple storage locations to guarantee redundancy, enable disaster recovery, and maintain business continuity. This is necessary as unexpected incidents, such as hardware malfunctions or cyberattacks, can interrupt data access and result in financial and reputational losses. Data replication typically involves copying information from a local primary storage site, which may be referred to herein as an “active storage site,” to a remote secondary storage site, which may be referred to herein as a “passive storage site.” When replicating data, data management systems often replicate source-tiering policies to the target data by default. However, this practice may not be optimal, as the access patterns for source data at the active storage site can differ significantly from those for the replicated data stored at the passive storage site. These differences in access behavior can lead to inefficiencies and increased costs when identical or similar tiering policies are extended to the passive storage site.

In accordance with example embodiments, the present application introduces techniques for adapting tiering practices to account for variations in access patterns between active and passive storage sites, which may improve overall system efficiency and cost-effectiveness. For example, disk endurance, defined as the ability of solid-state drives (SSDs) to handle a finite number of write and erase cycles before performance deteriorates or the drive fails, is an important cost consideration. Since SSDs utilize flash memory technology, excessive or uneven write operations can wear out specific memory cells faster, reducing overall lifespan and reliability. To address this, data tiering practices are proposed that can significantly enhance disk endurance and reduce costs. As detailed herein, the data tiering practices described herein can enhance such efficiencies—and improve disk endurance—by limiting the copying of certain types of data to solid-state drives only when data usage patterns dictate a need for it. In this way, the data tiering practices disclosed herein can reduce unnecessary writes to SSDs, alleviating stress on the drives and prolonging their operational lifespan.

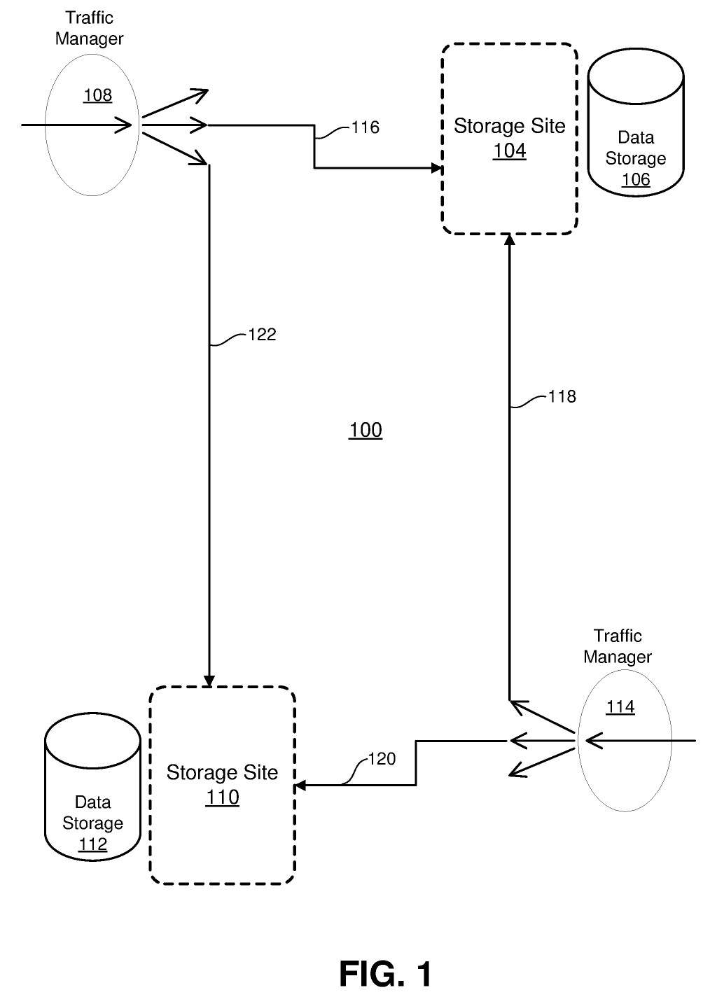

With reference to FIG. 1, an example data management system 100 is shown in which aspects of the present application may be utilized. As depicted, the data management system 100 may include two geographically separated storage sites, a storage site 104 and storage site 110. The storage site 104 may store data in a data storage 106, while the storage site 110 may store data in a data storage 112. Each storage site may operate in coordination with a corresponding traffic manager—a traffic manager 108 for the storage site 104 and a traffic manager 114 for the storage site 110. The storage sites 104 and 110 may be configured to function in an active-passive configuration relative to the traffic managers 108 and 114. For example, data may be replicated from one storage site to the other for redundancy and fault tolerance, which may increase efficiency and system reliability. For example, in relation to original or source data, the storage site 104 may serve as a primary or active storage location for the traffic manager 108 via a connection (e.g., network connection) 116, while concurrently, in relation to replicated or backup data, acting as a secondary or passive storage site for the traffic manager 114 via a connection 118. Similarly, in relation to original or source data, the storage site 110 may serve as the primary or active storage location for the traffic manager 114 via a connection 120 and, in relation to replicated or backup data, act as a secondary passive storage site for the traffic manager 108 via a connection 122. The described arrangement may allow the data management system 100 to balance and redirect data traffic between active and passive storage resources as necessary.

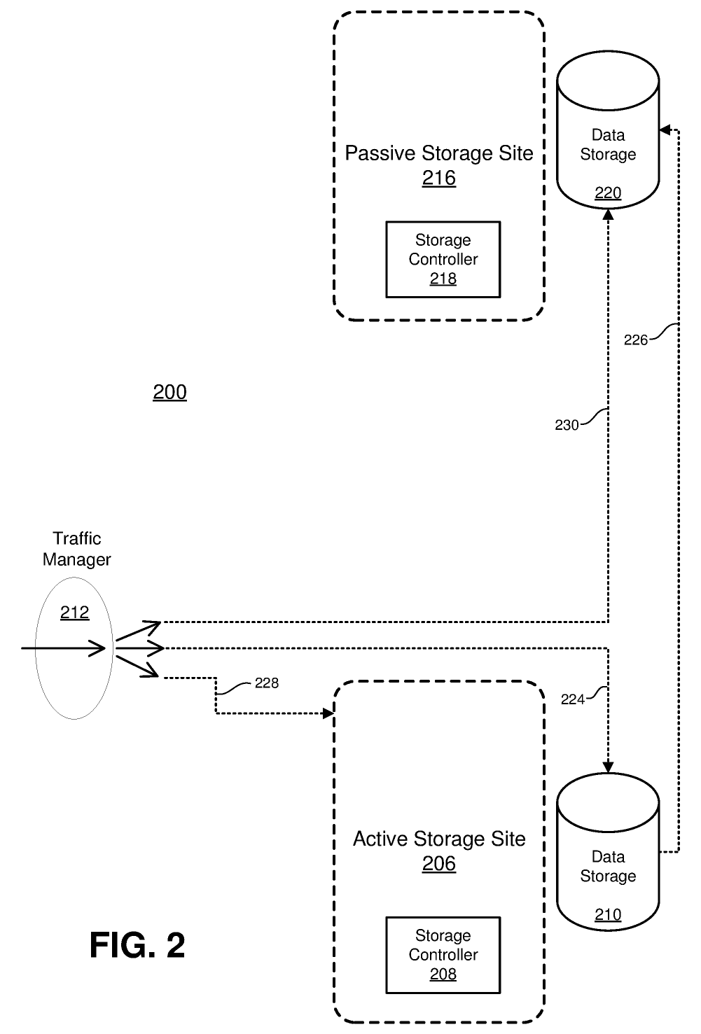

In an alternative arrangement, the data management system 100 may utilize a global traffic manager to oversee both storage sites that facilitates efficient coordination and improve site failover capabilities by dynamically redirecting traffic to an available storage site in the event of a failure. Additionally, a global traffic manager could be integrated alongside the existing two illustrated local traffic managers 108 and 114. In such a case, the global traffic manager may work in tandem to provide a hierarchical traffic management system. This combined approach may facilitate both localized control and global oversight to enhance performance and site failover mechanisms. As will be appreciated, the traffic manager shown in FIGS. 2-5 could also be implemented as a global traffic manager.

Each of the traffic managers 108 and 114 may be primarily responsible for directing data traffic to its designated local active storage site. Thus, upon receiving a data request, for example, the traffic manager 108 may prioritize fulfilling the request from its local active storage site, which is the storage site 104. Similarly, the traffic manager 114 may direct incoming traffic to its local active storage site, which is the storage site 110. This primary reliance on designated local storage sites may minimize latency, as the traffic manager and active storage site are local to each other and optimized for direct interaction. Moreover, by maintaining active and passive site roles, the system may streamline data access, reduce potential resource contention and minimize response times for most transactions under normal operating conditions.

In cases where an active storage site cannot fulfill a request—such as during a temporary outage or scheduled maintenance—a traffic manager may dynamically shift its operations to a passive storage site. For example, if the storage site 104 is unable to process a request directed to it by the traffic manager 108, the traffic manager 108 may reroute the request to the storage site 110, which is configured to act as a passive resource in this scenario. This redundancy may provide for continued data availability and minimize disruption. The traffic manager 114 may operate in a similar manner, relying on storage site 104 as its passive site when storage site 110 cannot fulfill a given request. The dual active-passive configuration may distribute workload efficiently while also providing for fault tolerance. As will be appreciated, the data management system 100 may integrate other storage sites to achieve further redundancies and operational advantages.

As will be appreciated, the connections link traffic managers to corresponding active storage sites. For instance, the connection 116 connects the traffic manager 108 to the storage site 104, and the connection 120 links the traffic manager 114 to the storage site 110. These connections are configured to allow high-speed, low-latency communication. The connection 118 and the connection 122, on the other hand, enable cross-site communication between the geographically separated storage sites and traffic managers. Specifically, the connection 118 establishes a link between the traffic manager 114 and the storage site 104, allowing for inter-site data synchronization and replication. Similarly, the connection 122 connects the traffic manager 108 to the storage site 110, providing an alternative pathway for the traffic manager 108 to access data from the storage site 110 when needed. As used herein, each of the connections represents a pathway for data communication, which may include high-speed physical links like fiber optics, secure cloud networking, wireless protocols, virtual private networks (VPNs), secure cloud interconnects, or other communication technologies.

The data management system 100 may support data requests through the described connections, utilizing a hierarchical approach to ensure efficient fulfillment. For example, when a data request is received, the traffic manager may first attempt to fulfill the request through its associated active storage site. If the active storage site cannot fulfill the request—due to an outage, maintenance, or other contingencies—the traffic manager may redirect the request to a passive storage site. For example, if a user connected to the traffic manager 108 requests data that is unavailable at the storage site 104, the request may be rerouted to the storage site 110. This hierarchical handling of data request facilitates reduced latency and improves system reliability under various conditions.

With reference now to FIG. 2, a data management system 200 is illustrated that depicts an example of operation according to various embodiments. The storage management system 200 may manage data storage operations between geographically separated storage sites. In the example shown, the storage management system 200 is presented in relation to a traffic manager 212 that is associated with two storage sites, including an active storage site 206 and a passive storage site 216. The active storage site 206 and the passive storage site 216 may include storage controllers 208 and 218, respectively. In example embodiments, each storage controller may be responsible for managing local storage resources at each site. Additionally, the storage controllers 208 and 218 may collectively implement overall data storage logic and system functionality within the storage management system 200. Alternatively, control could be centralized through a single controller that manages system-wide operations.

The active storage site 206 and the passive storage site 216 further may include data storage 210 and 220, respectively. As discussed more below, the data storage at each site may include a variety of data storage devices and servers that utilize different storage mediums to meet performance and capacity needs. For example, as discussed more below, storage mediums may include solid-state drives (SSDs), NVMe storage, hard disk drives (HDDs), tape storage, and/or types.

The traffic manager 212 coordinates data requests from clients and directs them to the appropriate storage locations for fulfillment. Also referred to as a load balancer, traffic distributor, or application delivery controller, the traffic manager 212 operates as an intermediary between clients and the storage management system. By default, the traffic manager 212 may prioritize fulfilling requests via a primary storage site, such as active storage site 206, which, being geographically nearer, may minimize latency and reduce response time. If the active storage site 206 is unable to fulfill a request due to factors such as an outage or maintenance, the traffic manager 212 may dynamically reroute the request to a secondary storage site, such as the passive storage site 216. FIG. 2 illustrates this functionality, with dotted lines denoting a series of actions. Each dotted line corresponds to a specific action and visually connects the system components involved.

In the example of FIG. 2, action 224, referred to as “object_1 create,” represents the initial creation of an object (e.g., a data file) called “object_1.” When a client or application submits a request to create object_1, the traffic manager 212 processes this request through its designated active storage site, namely active storage site 206. This site is responsible for storing the primary instance of the object. The storage controller 208, which oversees the allocation of storage resources, writes the object to the data storage 210, and indexes it for future accessibility, making object_1 readily available for subsequent operations.

Continuing with the example of FIG. 2, action 226, referred to as “object_1 replicate,” represents the replication of object_1 for redundancy and fault tolerance. In this process, the active storage site 206 transmits a copy of object_1 to the passive storage site 216 via inter-site communication. The storage controller 208 at the active site retrieves object_1 from the data storage 210 and prepares it for transfer. Upon receiving the copy, the storage controller 218 at the passive site manages its storage in the data storage 220, ensuring synchronization with the primary instance at the active site. This replicated version of object_1 serves as a backup and is accessible in the event of a failure at the active storage site 206.

Continuing with the example of FIG. 2, action 228, referred to as “failure of object_1 read,” represents an inability to read object_1 from the active storage site 206. For instance, this action may occur when a client or application sends a request to access object_1 stored at the active storage site 206, but the request cannot be fulfilled. Such failures may arise due to factors like heavy traffic loads, ongoing maintenance, temporary outages, or other unexpected issues affecting the active site’s operations. Upon detecting this failure, the storage controller 208 at the active storage site 206 may either notify the requesting client or application of the issue or signal the traffic manager 212 to reroute the read request to the passive storage site 216.

Continuing with the example of FIG. 2, action 230, referred to as “object_1 read,” represents the successful fulfillment of a read request for object_1 by the passive storage site 216. Following the failed read attempt at the active storage site 206, the traffic manager redirects the request to the passive storage site 216. To complete this action, the storage controller 218 at the passive site retrieves the replicated instance of object_1 from the data storage 220 and fulfills the request. This redirection mechanism may provide uninterrupted access to data, even in the event of a failure at the active storage site 206.

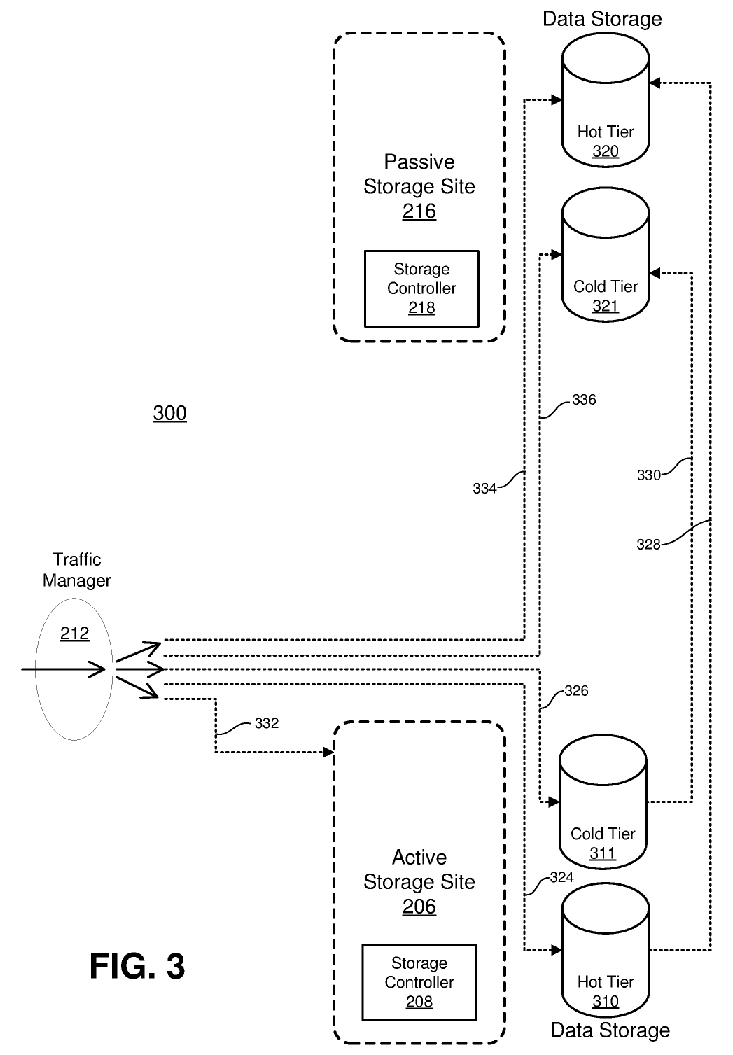

With reference now to FIG. 3, the redirection mechanism and related functionality is further described in relation to a data management system 300 having tiered storage. As used herein, tiered storage refers to a data management framework that organizes data across multiple tiers with varying performance, cost, and storage medium characteristics. For the sake of clarity, the present invention will be described in relation to a tiered storage system having two tiers. These tiers include a higher performance tier, referred to as a “high performance tier” or “hot tier,” which provides one or more superior performance characteristics compared to a lower performance tier, referred to as a “low performance tier” or “cold tier.”

As an example, the high-performance or hot tier may be designed to handle more critical or frequently accessed data requiring lower latency and faster read/write speeds. Accordingly, the hot tier may employ a higher performance storage medium, such as solid-state drives (SSDs) or NVMe (Non-Volatile Memory Express) storage, making it more suitable for AI/ML training datasets, high-frequency data access, transactional databases or real-time analytics. Because of the higher cost associated with such storage mediums, write amplification to the hot tier may be minimized to reduce the impact on disk endurance. On the other hand, the low-performance or cold tier may exhibit certain performance characteristics that are inferior in comparison to those of the hot tier. For example, the cold tier may provide a more cost-effective solution for storing less frequently accessed or less critical data. Accordingly, the cold tier may use a lower performance storage medium, such as hard disk drives (HDDs) or tape storage. The cold tier may be more suitable for long-term compliance records or backups and similar use cases.

While the invention of the present application is being described in relation to a two-tiered system having hot and cold tiers, it should be understood that the present invention may be applied to any tiered storage systems, for example, systems having other types or number of tiers. Unless otherwise limited, the “hot” and “cold” designations used herein refer only to a relative performance differential between tiers, in which the hot tier is superior in at least one aspect of performance compared to the cold tier. As an example, many tiered systems include one or more middle tiers to bridge the gap between higher performance and lower cost. Such a middle tier could utilize hybrid storage solutions, such as a combination of SSDs and HDDs, to offer moderate performance at a balanced price point. The middle tier may be used for data that is occasionally accessed or requires intermediate processing speeds, making it a versatile option. In a three-tiered system, aspects of the present invention may be applied between any two of the tiers. It should be noted that references to “hot” and “cold” tiers or to tiers employing higher or lower performance storage mediums are contextual to relative differences between their performance characteristics. For example, the higher performance storage medium may provide a lower latency in data retrieval, a greater read/write throughput, a higher input/output operations per second (IOPS), or other types of improved performance. The reference herein to hot and cold tiers or a tier employing a higher performance storage medium and another tier employing a lower performance storage medium may apply to any tier storage system that includes at least two tiers defined by different performance characteristics.

Within a tiered storage system, policies may dictate how data classified or typed and stored or moved between the tiers. For example, fixed tiering policies may permanently assign particular data to specific tiers based on predefined criteria, such as keeping critical data in a higher performance tier and archival data in a lower performance tier. Alternatively, dynamic tiering policies allow data to move between tiers based on criteria such as access patterns, lifecycle, and other factors. For example, frequently accessed data may begin in the higher performance tier but migrate to the lower performance tier after becoming less active, only to return to a higher tier if activity increases. Such dynamic policies may enhance cost-efficiency while ensuring performance remains aligned with evolving data needs.

With specific reference now to FIG. 3, the data management system 300 may include storage sites having storage tiers differentiated by the type of storage medium used in each. As illustrated, the active storage site 206 may include a hot tier 310 and a cold tier 311 that utilize a higher performance storage medium and lower performance medium, respectively. The passive storage site 216 may be similarly configured. The passive storage site 216 may include a hot tier 320 and a cold tier 321 that utilize the same higher performance and lower performance mediums, respectively.

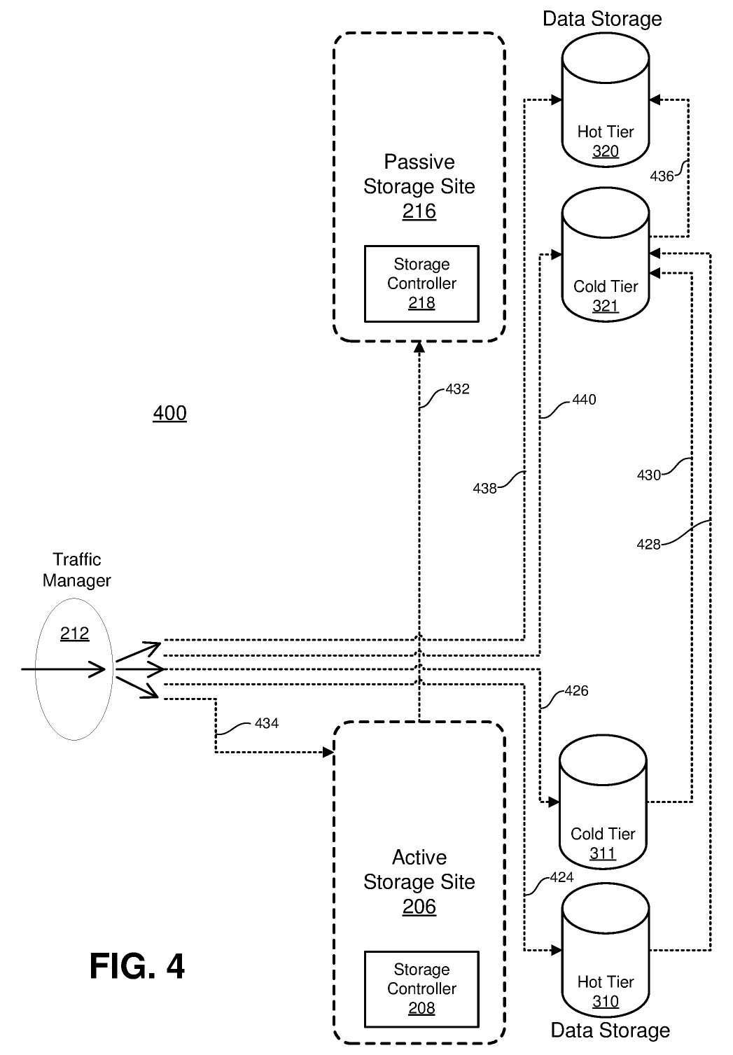

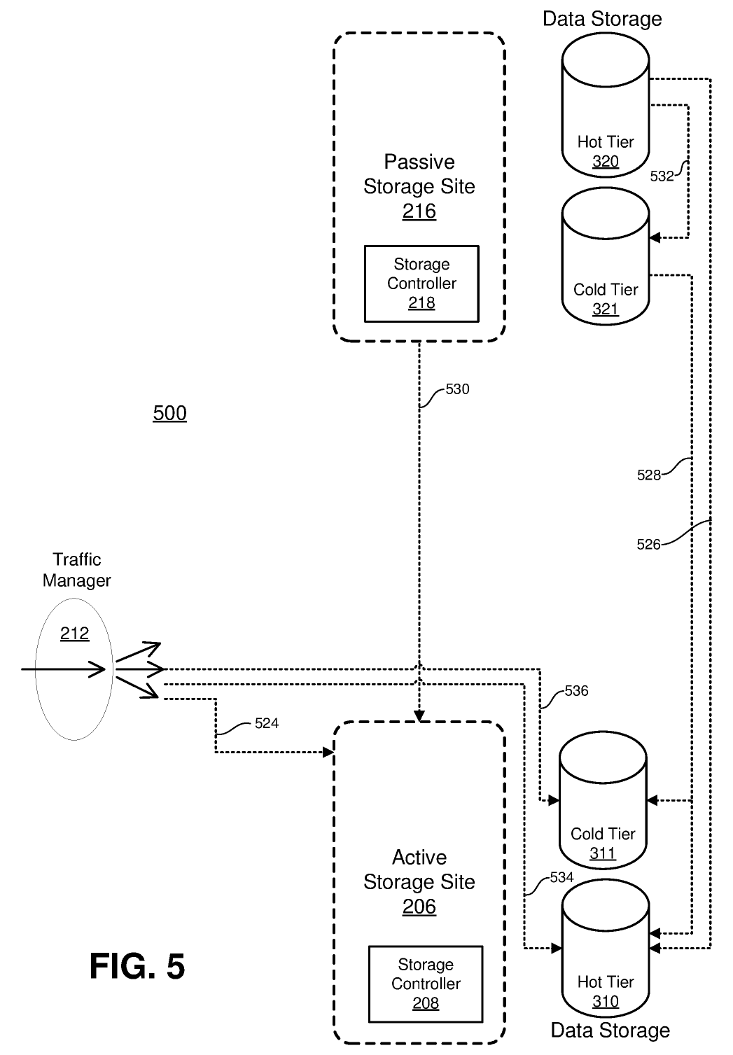

As in FIG. 2, the dotted lines in FIG. 3 collectively represent a series of actions. Each dotted line corresponds to a specific action and visually connects the components or nodes involved. These actions demonstrate a certain functionality in which data is replicated from active to passive storage sites for storage in corresponding tiers. Specifically, for example, this would include data stored in a hot tier at a first storage site being replicated to a hot tier at a second storage site, and data stored in a cold tier at the first storage site being replicated to a cold tier at the second storage site. However, as will be observed, defaulting replicated data to the same tier as the source tier can present certain inefficiencies. One reason for this is that the access patterns for the data are different between the two storage sites. The usage patterns differ because one storage site typically serves as a primary source for particular data, fulfilling most requests under normal conditions, while the secondary storage site experiences significantly reduced access activity since it is largely utilized only when the primary site is unavailable. The functionality depicted in FIG. 3 does not account for this disparity in usage patterns, as the depicted tiering practices default replicated data to the same tier as the source tier. To address this limitation, the alternative functionality presented below in relation to FIGS. 4 and 5 adapts tiering and replication strategies to better account for these differences, improving resource allocation, performance, and system efficiency.

In the example of FIG. 3, action 324, referred to as “object_1 create,” represents the initial creation of an object (e.g., a data file) called “object_1.” Similarly, action 326, referred to as “object_2 create,” represents the initial creation of an object (e.g., a data file) called “object_2.” The storage controller 208 oversees the allocation of storage resources, writes the objects, and indexes them for storage in the hot and cold tiers based on the applicable policies. In this example, object_1 is stored in the hot tier 310 of the active storage site 206, while object_2 is stored in the cold tier 311 of the active storage site 206.

Continuing with the example of FIG. 3, action 328, referred to as “object_1 replicate,” and action 330, referred to as “object_2 replicate,” represent the replication of object_1 and object_2, respectively, for redundancy and fault tolerance. For instance, the active storage site 206 may transfer copies of object_1 and object_2 to the passive storage site 216 through inter-site communication, as discussed earlier. These replicated objects serve as backups that can be accessed if a failure or outage occurs at the active storage site 206. As will be appreciated, each object is replicated to a corresponding tier. Specifically, object_1, initially stored in the hot tier 310 of the active storage site 206, is replicated to the hot tier 320 of the passive storage site 216. Similarly, object_2, stored in the cold tier 311 of the active storage site 206, is replicated to the cold tier 321 of the passive storage site 216.

In the event of a failure to read object_1 and object_2 from the active storage site 206, represented as action 232 (“failure of object_1 and object_2 read”), the storage controller 208 at the active storage site 206 identifies the failure and prompts the traffic manager 212 to reroute the read requests to the passive storage site 216.

Subsequently, action 334, referred to as “object_1 read,” represents the successful fulfillment of a read request for object_1 from the passive storage site 216. Similarly, action 336, referred to as “object_2 read,” represents the successful fulfillment of a read request for object_2 from the passive storage site 216. Specifically, in response to the failed read request at the active storage site 206, the traffic manager 212 redirects the read requests for both object_1 and object_2 to the passive storage site 216, enabling the replicated versions of the data to be accessed and fulfilling the requests.

However, while the data requests were fulfilled, the system’s tiering practices were inefficient in that they failed to account for disparities in access patterns between active and passive storage sites. This inefficiency is addressed in the functionality described in FIGS. 4 and 5, which introduces mechanisms to optimize tiering strategies and better align data replication practices with access patterns.

With reference now to FIG. 4, a tiered data management system 400 is illustrated, demonstrating alternative functionality in accordance with various example embodiments. As access patterns differ between active and passive storage sites, automatically applying tiering policies from the source site (i.e., the active storage site) to the passive site may not be operationally efficient. Instead, in accordance with example embodiments, replicated data at the passive storage site is initially stored on a default tier. In example embodiments, the default tier may be any tier on the passive storage site that offers lower performance characteristics in comparison to a tier used in the storage of the source data at the active storage site, as determined by the active storage site’s tiering policies or logic. In the example two-tiered system of FIG. 4, the default tier is the cold tier.

In accordance with example embodiments, once the active storage site becomes unavailable—such as during a temporary outage—its tiering policies and logic may be implemented at the passive a storage site for the data replicated there. This may be achieved, for example, by migrating data from the default tier, such as the cold tier, to the hot tier such that the resulting tiering at the passive storage site of the replicated data mimics the original tiering of the source data at the active storage site. With the active storage site unavailable, the access patterns for the data replicated at the passive storage site will begin to closely mirror the access patterns typically seen for the source data at the active storage site, as the requests that are usually directed to the active storage site are rerouted to the passive storage site. Given these similar access patterns, the implementation of the active storage site’s tiering logic at the passive storage site may enhance performance at the passive storage site during the temporary outage.

Additional aspects of this example functionality will now be described in relation to the actions illustrated in FIG. 4. Similar to prior examples, the dotted lines in FIG. 4 collectively represent a series of actions. Each dotted line corresponds to a specific action and visually connects the relevant components or nodes involved in that action.

In the example of FIG. 4, action 424, referred to as “object_1 create,” represents the initial creation of an object (e.g., a data file) called “object_1.” Similarly, action 426, referred to as “object_2 create,” represents the initial creation of an object (e.g., a data file) called “object_2.” The storage controller 208 oversees the allocation of storage resources and indexes the objects for storage in the hot and cold tiers in accordance with the applicable policies. In the present scenario, object_1 is stored in the hot tier 310 of the active storage site 206, while object_2 is stored in the cold tier 311 of the active storage site 206.

Continuing with the example of FIG. 4, action 428, referred to as “object_1 replicate,” and action 430, referred to as “object_2 replicate,” represent the replication of object_1 and object_2, respectively, to ensure redundancy and fault tolerance. For instance, the active storage site 206 transfers copies of object_1 and object_2 to the passive storage site 216 via inter-site communication, as previously discussed. These replicated objects serve as backups, enabling access in the event of a failure at the active storage site 206. Unlike the configuration in FIG. 3, where replicated data defaulted to corresponding tiers, both object_1 and object_2 are initially stored on a default tier at the passive storage site 216, which is the cold tier 321. Thus, although object_1 was stored in the hot tier 310 of the active storage site 206, it is replicated to the cold tier 320 of the passive storage site 216. Object_2, originally stored in the cold tier 311 of the active storage site 206, is also replicated to the cold tier 321 of the passive storage site 216. The manner in which the replicated data is stored in a default tier may also be referred to as an initial or first tiering mode.

Continuing with the example of FIG. 4, action 432 represents the transmission of tiering policies and data on access metrics from the active storage site 206 to the passive storage site 216. In this context, the tiering policies define how data is classified and tiered at the active storage site 206. The access metrics may include information related to the usage patterns of the replicated data at the active storage site. The access metrics may be continuously updated to ensure that the metadata associated with the replicated data remains current and accurate at the passive storage site 216. In systems governed by dynamic tiering policies, the access metrics, for instance, may be used to determine how data is classified and moved between tiers based on factors such as usage patterns, frequency of access, or lifecycle. As will be seen, by maintaining up-to-date access metrics, the system can make appropriate tiering decisions for the replicated data at the passive storage site in case of an outage at the active storage site.

Continuing with the example of FIG. 4, an action 434, referred to as “failure of object_1 and object_2 read,” represents a failure to read object_1 and object_2 from the active storage site 206. The storage controller 208 at the active storage site 206 may identify the failure and prompt the traffic manager 212 to reroute the read request to the passive storage site 216. The detection of this failure or unavailability of the active storage site 206 may signal an operational disruption is ongoing and serve as a triggering event that initiates the subsequent step.

Continuing with the example of FIG. 4, action 436 represents the migration of at least a portion of the replicated data stored in the default or cold tier 321 to the hot tier 320 of the passive storage site 216. This process may include identifying that portion of the replicated or copied data—referred to herein as a “migration portion”—and then instructing that this portion be migrated from the cold tier to the hot tier at the passive storage site. In example embodiments, the migration portion is determined by applying the tiering policies of the active storage site to the replicated data at the passive storage site. Based on these tiering policies, the system identifies the migration portion of the replicated data that needs to be moved to the hot tier to more closely align the tiering of the replicated data with the tiering policies of the active storage site. For example, the migration portion may include data governed by fixed tiering policies that specify storage in the hot tier as well as data governed by dynamic tiering policies that are determined to belong in the hot tier based on access data metrics and usage patterns. As discussed more below, capacity restraints in the hot tier may prevent all of the data identified for migration from being migrated to the hot tier. In such cases, a prioritized portion of the identified migration portion may be migrated. In example embodiments, data governed by fixed tiering policies may be prioritized over data governed by dynamic tiering policies. Additional prioritization, for example, within the subset of data that is governed by dynamic tiering policies, may be applied based on access frequency, lifecycle stage, or other relevant data characteristics.

Continuing with the example of FIG. 4, action 438, referred to as “object_1 read,” represents the successful fulfillment of a read request for object_1 from the passive storage site 216, while action 334, referred to as “object_2 read,” represents the successful fulfillment of a read request for object_2 from the passive storage site 216. Specifically, following the failed read request at the active storage site 206, the traffic manager 212 redirects the read requests for object_1 and object_2 to the passive storage site 216. For object_1, the request is fulfilled using its replicated version that had been migrated to the hot tier 320 at the passive storage site 216. For object_2, the request is fulfilled using its replicated version that remained in the cold tier 321 of the passive storage site 216, reflecting a tiered approach to managing replicated data in according with example embodiments.

With reference now to FIG. 5, the tiered data management system 400 is illustrated, demonstrating further functionality in accordance with various example embodiments. This instance depicts how the data management system 400 responds once it is determined that the active storage site 206 is accessible again. The diagram uses dotted lines to represent a series of actions that collectively illustrate this functionality. Each dotted line corresponds to a specific action, visually connecting the relevant components or nodes involved in that action.

In the example of FIG. 5, action 524 represents a successful read request or another type of communication that notifies the traffic manager 212 that the active storage site 206 is once again operational and capable of fulfilling data requests. In example embodiments, this notification may serve to reestablishes the active storage site 206 as the primary source for data and initiates a series of recovery operations.

Following the notification, actions 526 and 528 are triggered, representing the replication of new data created during the outage from the passive storage site 216 to the active storage site 206. Specifically, action 526 involves the replication of new data that was stored in the hot tier 320 of the passive storage site 216 to the hot tier 310 of the active storage site 206. Action 528, on the other hand, involves the replication of new data that was stored in the cold tier 321 of the passive storage site 216 to the cold tier 311 or, in certain cases, the hot tier 310 of the active storage site 206. As will be appreciated, due to capacity constraints in the hot tier 320 at the passive storage site 216, some of the new data stored in the cold tier 321 may qualify for storage in the hot tier 310 of the active storage site 206 when replicated there.

Continuing with the example of FIG. 5, action 530 represents the transmission of access metrics and metadata accumulated during the outage from the passive storage site 216 to the active storage site 206. This step ensures consistency between the two sites by synchronizing metadata. Such access metrics may provide insights into data usage patterns and lifecycle events that occurred during the outage, influencing tiering decisions for data governed by dynamic policies. Such access metrics may apply to new data created during the outage and to existing data that was accessed or modified during this period. By transferring these metrics, the active storage site 206 may regain the necessary contextual information to maintain its tiering and data management processes.

Following the synchronization of access metrics, action 532 represents the return of data that was migrated to the hot tier 320 at the passive storage site 216 during the outage. In accordance with example embodiments, once the active storage site 206 is fully operational, the passive storage site 216 may begin reverting to its default configuration, where replicated data resides in a default tier, i.e., the cold tier 321. In certain embodiments, data may remain, at least temporarily, in the hot tier 320 of the passive storage site 216 until it is evicted by other data designated for the hot tier. This mechanism can streamline operations by eliminating the need to remigrate the data back to the hot tier 320 should the active storage site 206 become unavailable again before the data is evicted.

Finally, actions 534 and 536 demonstrate the successful fulfillment of read requests from the hot tier 310 and the cold tier 311, respectively, of the active storage site 206. For example, action 534, may represent a successful read request related to new data replicated back to the hot tier 310 of the active storage site 206 upon resuming operations. Similarly, action 536 may represent a successful read request related to new data replicated back to the cold tier 311 of the active storage site 206. These actions may reestablish the role of the active storage site 206 as the primary source for the data.

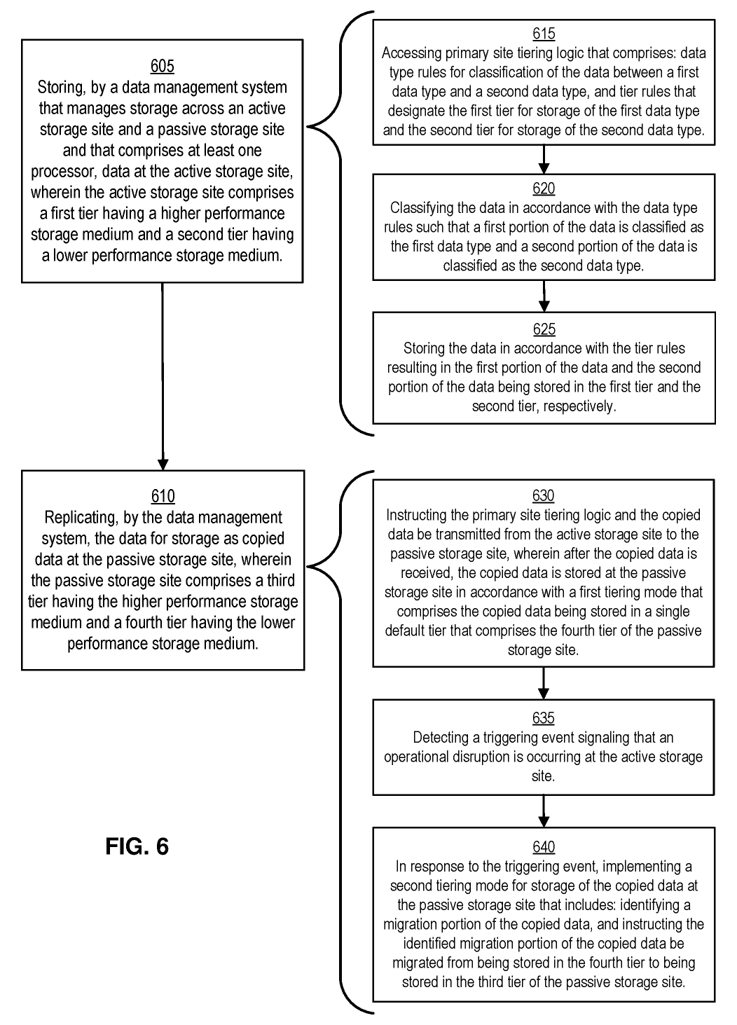

The example embodiments of FIGS. 4 and 5 describe a tiered storage system that achieves enhanced operational efficiencies by, for example, dynamically adjusting how replicated data is tiered at a passive storage site based on the availability of an active storage site. As shown in FIG. 4, disparities in data access patterns between storage sites may be addressed by initially storing replicated data in a default low-performance tier at the passive storage site and then applying the active storage site’s tiering policies selectively, such as during an outage. In the example embodiments of FIG. 5, recovery processes are described for efficiently transitioning to normal operating conditions once the active storage site becomes available again, including, for example, how data may be re-tiered at the passive storage site and synchronized across the storage sites. The discussion now transitions to FIGS. 6-8, which present particular methods in accordance with example embodiments.

Referring now to FIG. 6, a method 600 is shown for managing data storage across tiered active and passive storage sites according to an example embodiment. The method 600 may be implemented by a data management system that includes at least one processor.

At 605, the method 600 includes the act of storing data at the active storage site. The active storage site may comprise a first tier (which represents a hot tier) having a higher performance storage medium and a second tier (which represents a cold tier) having a lower performance storage medium. The act 605 of storing data at the active storage site may be further defined by a first subroutine, as indicated by acts 615 – 625, which is discussed below.

At 610, the method 600 then includes the act of replicating the data for storage as copied data at the passive storage site. The passive storage site may comprise a third tier (which represents a hot tier) having the higher performance storage medium and a fourth tier (which represents a cold tier) having the lower performance storage medium. The act 610 of replicating the data for storage as copied data at the passive storage site may be further defined by a second subroutine, as indicated by acts 630 – 640, which is discussed below.

The first subroutine may include the following. At 615, the first subroutine includes the act of accessing primary site tiering logic that applies to the active storage site. The primary site tiering logic may comprise: data type rules for classification of the data between data types, the data types comprising at least a first data type and a second data type, and tier rules that designate tiers in which respective data types are stored, the tier rules designating the first tier for storage of the first data type and the second tier for storage of the second data type.

At 620, the first subroutine includes the act of classifying the data in accordance with the data type rules. The classifying may result in a first portion of the data being classified as the first data type and a second portion of the data being classified as the second data type.

At 625, the first subroutine includes the act of storing the data in accordance with the tier rules. The storing may result in the first portion of the data and the second portion of the data being stored in the first tier and the second tier, respectively.

The second subroutine may include the following. At 630, the second subroutine includes the act of instructing the primary site tiering logic and the copied data be transmitted from the active storage site to the passive storage site. After the copied data is received by the passive storage site, the copied data may be stored at the passive storage site in accordance with a first tiering mode. The first tiering mode may comprise the copied data being stored in a single default tier that comprises the fourth tier of the passive storage site.

At 635, the second subroutine includes the act of detecting a triggering event signaling that an operational disruption is occurring at the active storage site.

At 640, the second subroutine includes the act of, in response to detecting the triggering event, implementing a second tiering mode for storage of the copied data at the passive storage site. The implementing of the second tiering mode may comprise: identifying a migration portion of the copied data, resulting in an identified migration portion, and instructing the identified migration portion of the copied data be migrated from being stored in the fourth tier to being stored in the third tier of the passive storage site.

In example embodiments, the active storage site and the passive storage site may be geographically separated. In example embodiments, the second tiering mode includes the copied data at the passive storage site being tiered according to the primary site tiering logic.

In example embodiments, the operational disruption refers to a temporary outage at the active storage site that renders the data stored there inaccessible. In example embodiments, the triggering event may further include the expiration of a predetermined delay period. In this case, a delay period is required to expire after the unavailability of the active storage site is detected before the triggering event is deemed to occur. The length of the delay period may be configured to exclude minor network disruptions from constituting the triggering event.

In example embodiments, the higher-performance storage medium offers a superior performance characteristic compared to the lower-performance storage medium. The superior performance characteristic may include a lower latency in data retrieval, a greater read/write throughput, or a higher input/output operations per second. In example embodiments, the higher-performance storage medium comprises solid-state drives, and the lower-performance storage medium comprises hard disk drives.

In example embodiments, data type rules classify data and, once used, may be used to determine a storage tier for the data. For example, for data governed by fixed tiering policies, the classification may be determined by a corresponding fixed tiering policy, i.e., governing definitions by which data can be classified. Once determined, the data is then fixed within a particular tier. For data governed by a dynamic tiering policy, the classification may be based on one or more metrics defining the data’s usage pattern, which may include how frequently the data is being accessed, lifecycle data, etc. In this case, changes in the usage pattern or lifecycle of data, as reflected in access metrics and other metadata, may cause the data to be reclassified and moved to a different tier.

In example embodiments, identifying the migration portion of the copied data involves determining a first portion of the copied data and a second portion of the copied data. In such cases, the first portion of the copied data may be data determined to be of the first data type, and the second portion of the copied data may be data determined to be of the second data type. The migration portion may be identified as the first portion of the copied data (i.e., data determined to be of the first data type and, thus, meant for storage in a higher performance tier).

In example embodiments, replicating the copied data includes instructing that access metrics associated with the copied data be transmitted from the active storage site to the passive storage site. In example embodiments, the determination of the first and second portions of the copied data may rely on the access metrics. For example, the access metrics for the data may be used to evaluate whether a threshold defined within a dynamic tiering policy is satisfied, such as whether access frequency is sufficiently high).

In example embodiments, identifying the migration portion of the copied data involves determining a first portion and a second portion of the copied data. The first portion of the copied data may be data determined to be of the first data type, and the second portion of the copied data may be data determined to be of the second data type. In example embodiments, for instance when capacity constraints limited the amount of data that can be moved to the higher performance tier, the migration portion may comprise a prioritized part of the first portion of the copied data. In example embodiments, implementing the second tiering mode for storing copied data at the passive storage site may first include determining the available storage capacity in the third tier (i.e., the hot tier) of the passive storage site. In such instances, the prioritized part of the first portion of the copied data may be sized to align with the available storage capacity in the third tier. In example embodiments, in determining the prioritized part of the first portion of the copied data, the data in the first portion governed by a fixed tiering policy may be assigned a higher priority compared to the data governed by a dynamic tiering policy.

In example embodiments, the triggering event may be a first triggering event. In such cases, the step of replicating the data for storage at the passive storage site may further include detecting a second triggering event that signals the operational disruption at the active storage site is over. In response, the first tiering mode for storage of the copied data may be restored at the passive storage site. In example embodiments, the restoring the first tiering mode may include instructing that the identified migration portion of the copied data be returned from the third tier to the fourth tier. In example embodiments, this instruction may be carried out upon the data being eviction by other data identified for storage in the third tier.

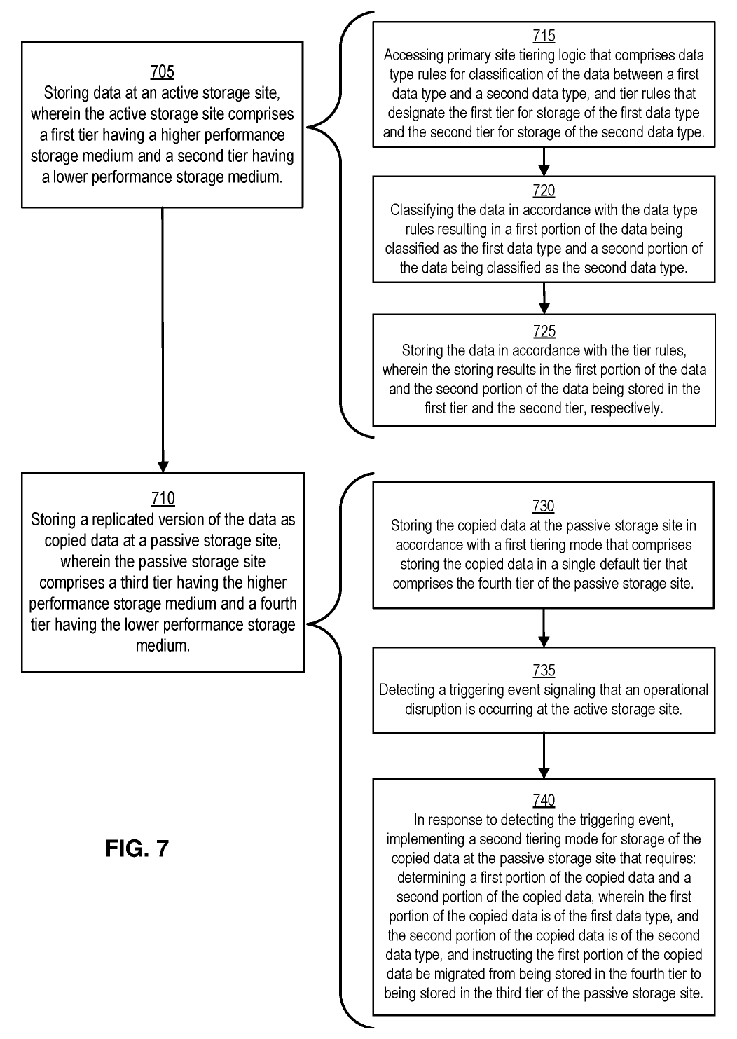

Referring now to FIG. 7, an alternative method 700 is shown for managing data storage across tiered active and passive storage sites according to example embodiments. The method 700 may be implemented by a data management system or storage controller that includes at least one processor.

At 705, the method 700 includes the act of storing data at an active storage site. The active storage site may comprise a first tier (which represents the hot tier) having a higher performance storage medium and a second tier (which represents the cold tier) having a lower performance storage medium. The act 705 of storing data at the active storage site may be further defined by a first subroutine, as indicated by acts 715 – 725, which is discussed below.

At 710, the method 700 includes the act of storing a replicated version of the data as copied data at a passive storage site. The passive storage site may comprise a third tier having the higher performance storage medium and a fourth tier having the lower performance storage medium. The act 710 of storing a replicated version of the data as copied data at the passive storage site may be further defined by a second subroutine, as indicated by acts 730 – 740, which is discussed below.

The first subroutine may include the following. At 715, the first subroutine includes the act of accessing primary site tiering logic that applies to the active storage site. The primary site tiering logic comprises data type rules for classification of the data between a first data type and a second data type, and tier rules that designate the first tier for storage of the first data type and the second tier for storage of the second data type.

At 720, the first subroutine includes the act of classifying the data in accordance with the data type rules. The classifying may result in a first portion of the data being classified as the first data type and a second portion of the data being classified as the second data type.

At 725, the first subroutine includes the act of storing the data in accordance with the tier rules. The storing may result in the first portion of the data and the second portion of the data being stored in the first tier and the second tier, respectively.

The second subroutine may include the following. At 730, the second subroutine includes the act of storing the copied data at the passive storage site in accordance with a first tiering mode. The first tiering mode may comprise storing the copied data in a single default tier that comprises the fourth tier of the passive storage site.

At 735, the second subroutine includes the act of detecting a triggering event signaling that an operational disruption is occurring at the active storage site.

At 740, the second subroutine includes the act of in response to detecting the triggering event, implementing a second tiering mode for storage of the copied data at the passive storage site that comprises: determining a first portion of the copied data and a second portion of the copied data (where the first portion of the copied data is of the first data type, and the second portion of the copied data is of the second data type), and instructing the first portion of the copied data be migrated from being stored in the fourth tier to being stored in the third tier of the passive storage site.

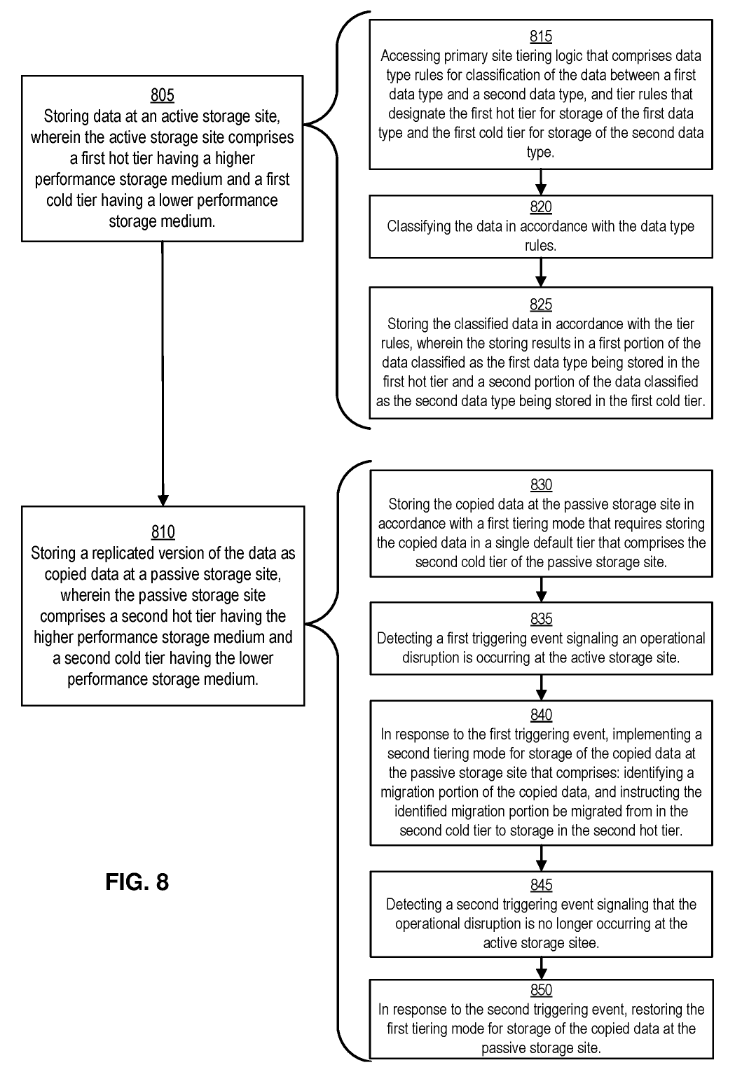

Referring now to FIG. 8, an alternative method 800 is shown for managing data storage across tiered active and passive storage sites according to example embodiments. The method 800 may be implemented by a data management system or storage controller that includes at least one processor.

At 805, the method 800 includes the act of storing data at an active storage site. The active storage site may comprise a first hot tier having a higher performance storage medium and a first cold tier having a lower performance storage medium. The act 805 of storing data at the active storage site may be further defined by a first subroutine, as indicated by acts 815 – 825, which is discussed below.

At 810, the method 800 includes the act of storing a replicated version of the data as copied data at a passive storage site. The passive storage site may comprise a second hot tier having the higher performance storage medium and a second cold tier having the lower performance storage medium. The act 810 of storing a replicated version of the data as copied data at the passive storage site may be further defined by a second subroutine, as indicated by acts 830 – 850, which is discussed below.

The first subroutine may include the following. At 815, the first subroutine includes the act of accessing primary site tiering logic that applies to the active storage site. The primary site tiering logic may comprise data type rules for classification of the data between a first data type and a second data type, and tier rules that designate the first hot tier for storage of the first data type and the first cold tier for storage of the second data type.

At 820, the first subroutine includes the act of classifying the data in accordance with the data type rules.

At 825, the first subroutine includes the act of storing the classified data in accordance with the tier rules. The storing may result in a first portion of the data classified as the first data type being stored in the first hot tier, and a second portion of the data classified as the second data type being stored in the first cold tier.

The second subroutine may include the following. At 830, the first subroutine includes the act of storing the copied data at the passive storage site in accordance with a first tiering mode. The first tiering mode may require storing the copied data in a single default tier that comprises the second cold tier of the passive storage site.

At 835, the second subroutine includes the act of detecting a first triggering event signaling that an operational disruption is occurring at the active storage site.

At 840, the second subroutine includes the act of, in response to detecting the first triggering event, implementing a second tiering mode for storage of the copied data at the passive storage site. The second tiering mode may comprise: identifying a migration portion of the copied data, resulting in an identified migration portion, and instructing the identified migration portion of the copied data be migrated from being stored in the second cold tier to being stored in the second hot tier of the passive storage site.

At 845, the second subroutine includes the act of detecting a second triggering event signaling that the operational disruption is no longer occurring at the active storage site.

At 850, the second subroutine includes the act of, in response to detecting the second triggering event, restoring the first tiering mode for storage of the copied data at the passive storage site.

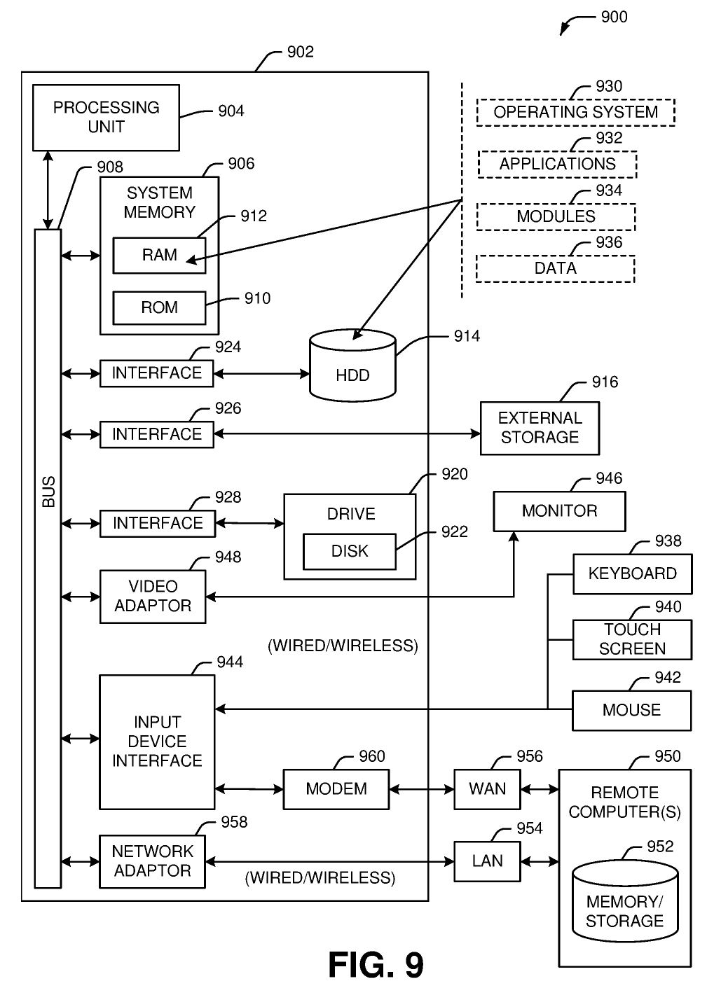

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where example tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various example embodiments described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and a drive 920, e.g., such as a solid state drive, an optical disk drive, which can read or write from a disk 922, such as a CD-ROM disc, a DVD, a BD, etc. Alternatively, where a solid-state drive is involved, disk 922 would not be included, unless separate. While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and drive 920 can be connected to the system bus 908 by an HDD interface 924, an external storage interface 926 and a drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above, such as, but not limited to, a network virtual machine providing one or more examples of storage or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

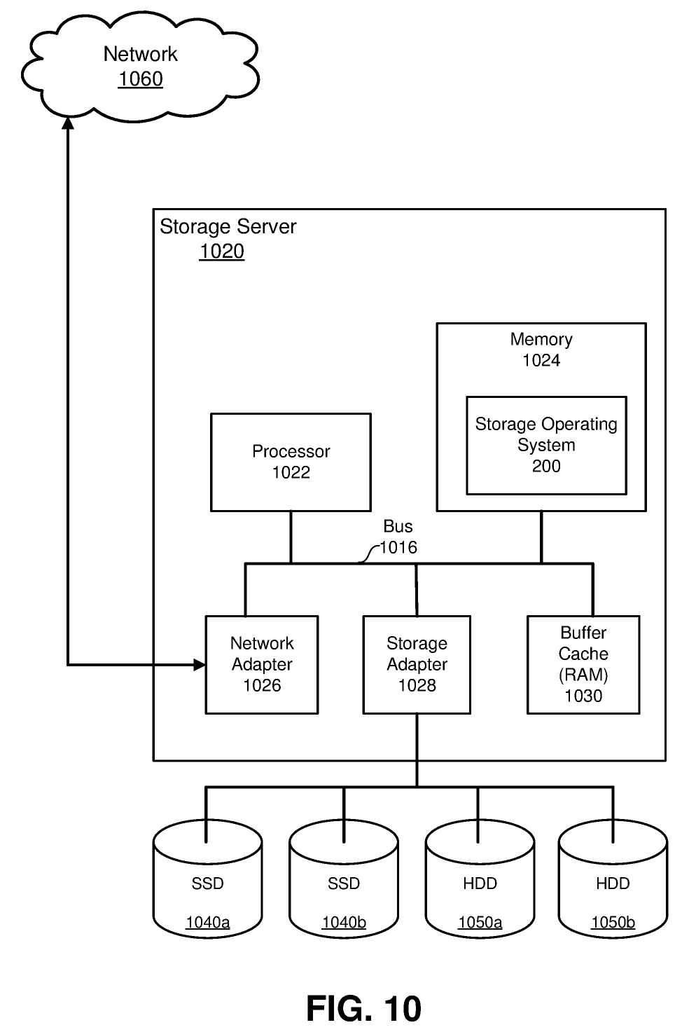

FIG. 10 illustrates a schematic block diagram of a storage server that may be advantageously used to implement example embodiments. In the illustrated embodiment, storage system 1000 includes a storage server 1020 including one or more processors 1022, a memory 1024, a network adapter 1026, a storage adapter 1028 and buffer cache 1030 interconnected by a system bus 1025. The storage server 1020 is a computer that provides storage services relating to the organization of information on writable, persistent storage media, such as SSDs and HDDs. The storage server 1020 may include a storage operating system 1032 that implements a file system to logically organize the stored data as a hierarchical structure of logical data containers (e.g., volumes, logical units, directories and/or files) on the electronic storage media 1040 and magnetic storage media 1050. It will be understood by those skilled in the art that this description may apply to any type of special-purpose computer (e.g., file server or storage serving appliance) or general-purpose computer embodied as, or having a storage server including a standalone computer or portion thereof. Moreover, the teachings of this description can be adapted to a variety of storage server architectures including, but not limited to, a network-attached storage (NAS), storage area network (SAN), or a disk assembly directly-attached to a client or host computer. The term “storage server” should therefore be taken broadly to include such arrangements.

In example embodiments, the memory 1024 may include storage locations that are addressable by the processor(s) 1022 and adapters for storing software programs and data structures to carry out the techniques described herein. Processor(s) 1022 and adapters may, in turn, include processing elements and/or logic circuitry configured to execute the software programs and manipulate the data structures. The storage operating system 1032, portions of which is typically resident in memory 1024 and executed by the processor(s) 1022, functionally organizes the storage server by invoking storage operations in support of software processes executing on the server 1020. It will be apparent to those skilled in the art that other memory mechanisms, such as various computer-readable media, may instead be used to store and execute program instructions pertaining to the embodiments described herein. The electronic storage media 1040 and magnetic storage media 1050 are configured to provide a persistent, writable storage space capable of maintaining data in the event of a power loss or other failure of the storage server 1020. Accordingly, the electronic storage media 1040 and magnetic storage media 1050 may be embodied as large-volume memory arrays.

In example embodiments, the network adapter 1026 may include the mechanical, electrical and signaling circuitry needed to connect the storage server 1020 to clients (not shown) over a computer network 1060, which may include a point-to-point (P2P) connection or a shared medium, such as a local area network (LAN). The client may be a general-purpose computer configured to execute applications, such as a database application. Moreover, the client may interact with the storage server 1020 in accordance with a client/server model of information delivery. That is, the client may request the services of the storage server 1020 and the system may return the results of the services requested by the client, such as by exchanging packets over the network 160. The client may issue packets including file-based access protocols such as the Common Internet File System (CIFS) protocol or Network File System (NFS) protocol over TCP/IP when accessing information in the form of files. Alternatively, the client(s) may issue packets including block-based access protocols such as the Small Computer Systems Interface (SCSI) protocol encapsulated over TCP (iSCSI) and SCSI encapsulated over FC (FCP) when accessing information in the form of LUNs or blocks.

In example embodiments, the storage adapter 1028 may cooperate with the storage operating system 1032 executing on the storage server 1020 to access information requested by the client. The information may be stored on the electronic storage media 1040 and magnetic storage media 1050, which are illustratively embodied as SSDs and HDDs. The storage adapter includes input/output (I/O) interface circuitry that couples to the SSD 1040 and HDD 1050 over an I/O interconnect arrangement, such as a conventional high-performance serial link topology. The information is retrieved by the storage adapter 1028 and, if necessary, processed by the processor(s) 1022 (or the adapter 1028) prior to being forwarded over the system bus 1025 to the network adapter 1026 where the information is formatted into a packet and returned to the client.

In the illustrated embodiment, buffer cache 1030 is coupled with the memory 1024 over the system bus 1025. However, this is by way of example and not of limitation as the buffer cache 1030 may be coupled with the memory using, for example, a point-to-point connection. In addition, the buffer cache 1030 may be separate from the memory 1024 (as illustrated), part of the memory 1024, or part of the processor(s) 1022. Generally, a buffer cache memory, such as buffer cache 1030, includes a smaller, lower-latency (faster) memory such as RAM (e.g., DRAM), operable to reduce the average time to perform a memory access. The buffer cache typically stores copies of the data from the most frequently used locations in memory 1024 so that when a memory access is performed, the buffer cache may first be checked to determine if required data is located therein, and, if so, the data may be accessed from the buffer cache 1030 instead of the persistent storage media, such as SSDs or HDDs. In this manner, a buffer cache, such as buffer cache 1030, reduces memory access times by avoiding having to access persistent storage to obtain the data.

What is claimed is:

1. A method, comprising:
storing, by a data management system that manages storage across an active storage site and a passive storage site and that comprises at least one processor, data at the active storage site, wherein the active storage site comprises a first tier having a higher performance storage medium and a second tier having a lower performance storage medium, the storing comprising:
accessing primary site tiering logic that applies to the active storage site, wherein the primary site tiering logic comprises:
data type rules for classification of the data between data types, the data types comprising at least a first data type and a second data type, and
tier rules that designate tiers in which respective data types are stored, the tier rules designating the first tier for storage of the first data type and the second tier for storage of the second data type,
classifying the data in accordance with the data type rules, wherein the classifying results in a first portion of the data being classified as the first data type and a second portion of the data being classified as the second data type, and
storing the data in accordance with the tier rules, wherein the storing results in the first portion of the data and the second portion of the data being stored in the first tier and the second tier, respectively; and
replicating, by the data management system, the data for storage as copied data at the passive storage site, wherein the passive storage site comprises a third tier having the higher performance storage medium and a fourth tier having the lower performance storage medium, the replicating comprising:
instructing the primary site tiering logic and the copied data be transmitted from the active storage site to the passive storage site, wherein after the copied data is received by the passive storage site, the copied data is stored at the passive storage site in accordance with a first tiering mode, the first tiering mode comprising the copied data being stored in a single default tier that comprises the fourth tier of the passive storage site,
detecting a triggering event signaling that an operational disruption is occurring at the active storage site, and
in response to detecting the triggering event, implementing a second tiering mode for storage of the copied data at the passive storage site, the implementing of the second tiering mode comprising:
identifying a migration portion of the copied data, resulting in an identified migration portion, and
instructing the identified migration portion of the copied data be migrated from being stored in the fourth tier to being stored in the third tier of the passive storage site.

2. The method of claim 1, wherein the active storage site and the passive storage site are geographically separated, and
wherein the second tiering mode comprises the copied data being tiered at the passive storage site in accordance with the primary site tiering logic.

3. The method of claim 1, wherein the higher performance storage medium comprises a superior performance characteristic compared to the lower performance storage medium, the superior performance characteristic comprising at least one of:
a lower latency in data retrieval,
a greater read/write throughput, or
a higher input/output operations per second.

4. The method of claim 1, wherein the higher performance storage medium comprises solid state drives and the lower performance storage medium comprises hard disk drives; and
wherein the triggering event further comprises an expiration of a predetermined delay period.

5. The method of claim 1, wherein the operational disruption comprises a temporary outage at the active storage site that renders the data stored at the active storage site inaccessible.

6. The method of claim 1, wherein the data type rules classify data by at least one of:
for data governed by fixed tiering policies, a tier classification provided in a corresponding fixed tiering policy; or
for data governed by a dynamic tiering policy, one or more metrics defining a usage pattern of the data.

7. The method of claim 1, wherein the identifying of the migration portion of the copied data comprises:
determining a first portion of the copied data and a second portion of the copied data, wherein the first portion of the copied data is of the first data type, and the second portion of the copied data is of the second data type, and
wherein the migration portion of the copied data comprises the first portion of the copied data.

8. The method of claim 1, wherein the replicating further comprises:
instructing access metrics associated with the copied data be transmitted from the active storage site to the passive storage site,
wherein the determination of the first portion and the second portion of the copied data comprises using the access metrics to determine whether a threshold defined within a dynamic tiering policy is satisfied.

9. The method of claim 1, wherein the identifying of the migration portion of the copied data comprises:
determining a first portion of the copied data and a second portion of the copied data, wherein the first portion of the copied data is of the first data type, and the second portion of the copied data is of the second data type, and
wherein the migration portion of the copied data comprises a prioritized part of the first portion of the copied data.

10. The method of claim 9, wherein the implementing of the second tiering mode for the storage of the copied data at the passive storage site further comprises:
determining an available storage capacity in the third tier of the passive storage site,
wherein the prioritized part of the first portion of the copied data is sized to correspond to the available storage capacity in the third tier of the passive storage site.

11. The method of claim 10, wherein, in determining the prioritized part of the first portion of the copied data, first data of the first portion of the copied data governed by a fixed tiering policy is assigned a higher priority in comparison to second data of the first portion governed by a dynamic tiering policy.

12. The method of claim 1, wherein the triggering event comprises a first triggering event;
wherein the replication of the data for storage as copied data at the passive storage site further comprises:
detecting a second triggering event signaling that the operational disruption is no longer occurring at the active storage site; and
in response to detecting the second triggering event, restoring the first tiering mode for storage of the copied data at the passive storage site.

13. The method of claim 12, wherein, the restoration of the first tiering mode further comprises:
instructing the identified migration portion of the copied data be returned from storage in the third tier to storage in the fourth tier upon an eviction of the identified migration portion by other data identified for storage in the third tier.

14. A data management system, comprising:
at least one processor; and
at least one memory that stores executable instructions that, when executed by the at least one processor, facilitate performance of operations, the operations comprising:
storing data at an active storage site, wherein the active storage site comprises a first tier having a higher performance storage medium and a second tier having a lower performance storage medium, the storage of the data at the active storage site comprising:
accessing primary site tiering logic that applies to the active storage site, wherein the primary site tiering logic comprises data type rules for classification of the data between a first data type and a second data type, and tier rules that designate the first tier for storage of the first data type and the second tier for storage of the second data type,
classifying the data in accordance with the data type rules, wherein the classifying results in a first portion of the data being classified as the first data type and a second portion of the data being classified as the second data type, and
storing the data in accordance with the tier rules, wherein the storing results in the first portion of the data and the second portion of the data being stored in the first tier and the second tier, respectively; and
storing a replicated version of the data as copied data at a passive storage site, wherein the passive storage site comprises a third tier having the higher performance storage medium and a fourth tier having the lower performance storage medium, the storage of the replicated version of the data comprising:
storing the copied data at the passive storage site in accordance with a first tiering mode that comprises storing the copied data in a single default tier that comprises the fourth tier of the passive storage site,
detecting a triggering event signaling that an operational disruption is occurring at the active storage site, and
in response to detecting the triggering event, implementing a second tiering mode for storage of the copied data at the passive storage site that comprises:
determining a first portion of the copied data and a second portion of the copied data, wherein the first portion of the copied data is of the first data type, and the second portion of the copied data is of the second data type, and
instructing the first portion of the copied data be migrated from being stored in the fourth tier to being stored in the third tier of the passive storage site.

15. The system of claim 14, wherein the active storage site and the passive storage site are geographically separated, and
wherein the second tiering mode comprises the copied data being tiered at the passive storage site in accordance with the primary site tiering logic.

16. The system of claim 14, wherein the higher performance storage medium comprises a superior performance characteristic compared to the lower performance storage medium, the superior performance characteristic comprising at least one of:
a lower latency in data retrieval,
a greater read/write throughput, or
a higher input/output operations per second.

17. The system of claim 14, wherein the operational disruption comprises a temporary outage at the active storage site that renders the data stored at the active storage site inaccessible, and
wherein:
the higher performance storage medium comprises solid state drives; and
the lower performance storage medium comprises hard disk drives.

18. The system of claim 14, wherein the triggering event comprises a first triggering event; and
wherein the storage of the copied data at the passive storage site in accordance with the first tiering mode further comprises:
detecting a second triggering event signaling that the operational disruption is no longer occurring at the active storage site; and
in response to detecting the second triggering event, restoring the first tiering mode for storage of the copied data at the passive storage site.

19. A method, comprising:
storing data at an active storage site, wherein the active storage site comprises a first hot tier having a higher performance storage medium and a first cold tier having a lower performance storage medium, the storing comprising:
accessing primary site tiering logic that applies to the active storage site, wherein the primary site tiering logic comprises data type rules for classification of the data between a first data type and a second data type, and tier rules that designate the first hot tier for storage of the first data type and the first cold tier for storage of the second data type,
classifying the data in accordance with the data type rules, and
storing the classified data in accordance with the tier rules, wherein the storing results in a first portion of the data classified as the first data type being stored in the first hot tier and a second portion of the data classified as the second data type being stored in the first cold tier; and
storing a replicated version of the data as copied data at a passive storage site, wherein the passive storage site comprises a second hot tier having the higher performance storage medium and a second cold tier having the lower performance storage medium, the storing comprising:
storing the copied data at the passive storage site in accordance with a first tiering mode that comprises storing the copied data in a single default tier that comprises the second cold tier of the passive storage site,
detecting a first triggering event signaling that an operational disruption is occurring at the active storage site,
in response to detecting the first triggering event, implementing a second tiering mode for storage of the copied data at the passive storage site, wherein the second tiering mode comprises:
identifying a migration portion of the copied data, resulting in an identified migration portion, and
instructing the identified migration portion of the copied data be migrated from being stored in the second cold tier to being stored in the second hot tier of the passive storage site,
detecting a second triggering event signaling that the operational disruption is no longer occurring at the active storage site, and
in response to detecting the second triggering event, restoring the first tiering mode for storage of the copied data at the passive storage site.

20. The method of claim 19, wherein the active storage site and the passive storage site are geographically separated, and
wherein the higher performance storage medium comprises a superior performance characteristic compared to the lower performance storage medium, the superior performance characteristic comprising at least one of:
a lower latency in data retrieval,
a greater read/write throughput, or
a higher input/output operations per second.
